(19) United States
(12) Patent Application Publication
(10) Pub. No.: US 2004/0239228 A1
(43) Pub. Date: Dec. 2, 2004

(54) Three-dimensional tungsten structure for an incandescent lamp and light source comprising said structure

(76) Inventors: Piero Perlo, Italy (IT); Anatolii Zezdine, Italy (IT); Rossella Monferino, Italy (IT); Denis Bollea, Italy (IT); Davide Capello, Italy (IT); Piermario Repetto, Italy (IT)

Correspondence Address: SUGHRUE MION, PLLC, 2100 PENNSYLVANIA AVENUE, N.W., SUITE 800, WASHINGTON, DC, 20037, US

(21) Appl. No.: 10/468,455

(22) PCT Filed: Dec. 18, 2002
(86) PCT No.: PCT/IB02/05551

(30) Foreign Application Priority Data
Jan. 11, 2002 (IT) TO2002A000031

(51) Int. Cl. H01K 1/00; H01J 19/08; H01J 1/15; H01K 1/50; H01K 1/02

(52) U.S. Cl. 313/341; 313/315; 313/578

(57) ABSTRACT

A three-dimensional structure in the form of filament (6) for an incandescent lamp comprises a plurality of tungsten microfilaments (6A) having micrometric and/or nanometric dimensions, to form a photonic crystal structure. The microfilaments (6A) are arranged so as to form a series of microcavities in the three-dimensional structure (6), a means having a refraction index different from that of tungsten being present within said microcavities. The described arrangement makes it possible to prevent propagation and spontaneous emission of IR radiation of specific wavelenghts e allows at the same time propagation and spontaneous emission of visible radiation.

### TEXT OF DESCRIPTION

The present invention relates to a three-dimensional tungsten structure, in particular a filament, for an incandescent lamp and to a light source, in particular an incandescent lamp, comprising a three-dimensional tungsten structure.

Traditional incandescent lamps, comprising a three-dimensional tungsten structure in filament form, currently cover about 40% of the market of light sources, despite the fact that their efficiency reaches a maximum value of 5-7%.

This limit value is imposed by Planck's law, which provides the spectral intensity I(λ) of the radiation emitted by the tungsten filament of the lamp at the temperature T of equilibrium. The energy irradiated by the tungsten filament in the visible interval of the electromagnetic spectrum is proportional to the curve integral I(λ) between λ₁=380 nm and λ₂=780 nm, and reaches a maximum of 5-7% of the total energy.

According to the above, the object of the present invention is to produce a three-dimensional tungsten structure for incandescent lamps, in particular in filament form, with increased efficiency and which thus makes it possible to save energy.

This object is attained, according to the present invention, by a three-dimensional tungsten structure, in particular a filament, for an incandescent lamp, comprising a plurality of tungsten microfilaments with micrometric and/or nanometric dimensions, preferably with a circular or quadrangular section, disposed in the space to form a photonic crystal structure.

The aforesaid object is also attained, according to the present invention, by a light source, in particular an incandescent lamp, comprising a bulb inside which a three-dimensional tungsten structure is disposed, in particular a filament, wherein said structure is in the form of a photonic crystal, that is defining a series of microcavities in which a means with a different refraction index to tungsten is present.

Further objects, characteristics and advantages of the present invention shall become apparent in the description hereunder and from the attached drawings, provided purely as a non-limitative explicative example in which:

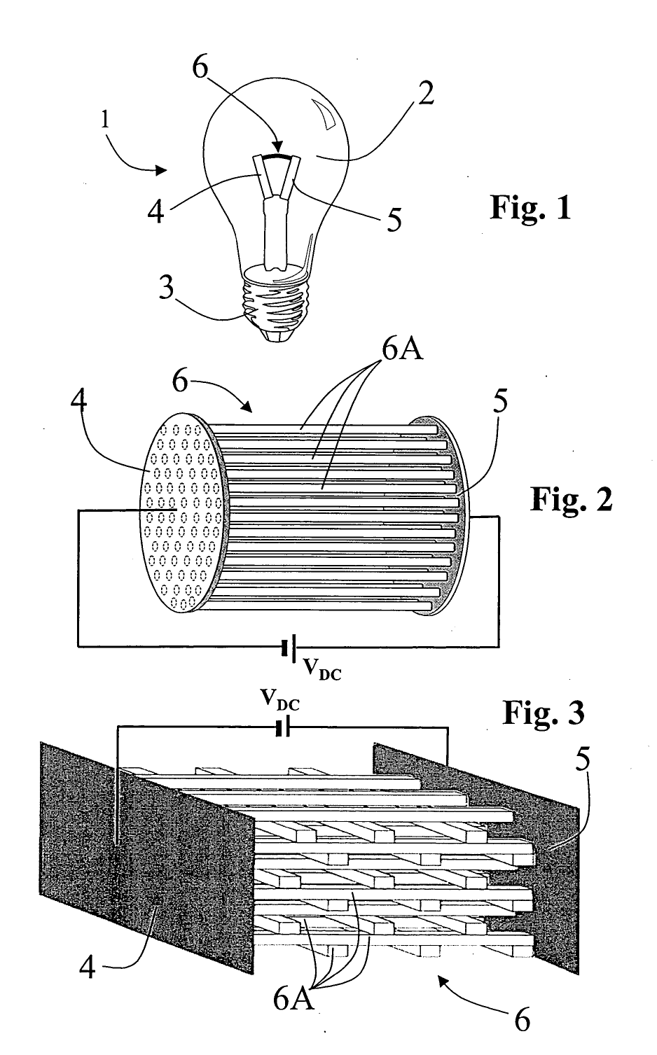

FIG. 1 is a schematic elevation of an incandescent lamp comprising a tungsten filament according to the invention;

FIG. 2 is a perspective schematic view of a first possible embodiment of the tungsten filament of the lamp in FIG. 1;

FIG. 3 is a perspective schematic view of a second possible embodiment of the tungsten filament of the lamp in FIG. 1;

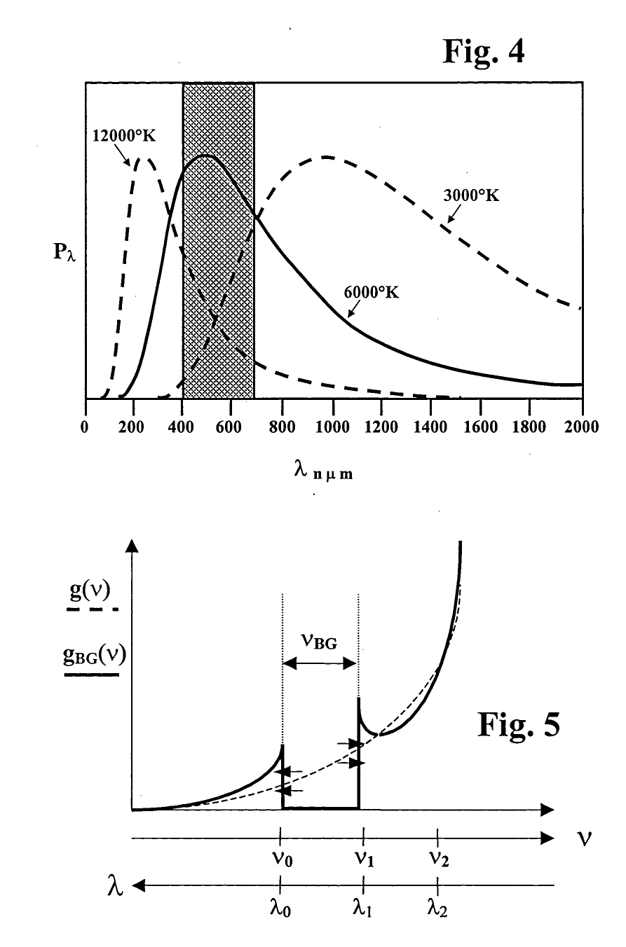

FIG. 4 is a graphic representation of the black-body radiation spectrum for light sources at temperatures of 3,000, 6,000 and 12,000 K, as a function of the wavelength;

FIG. 5 is a schematic representation of the density of photonic states in a traditional material and in a material with band gap;

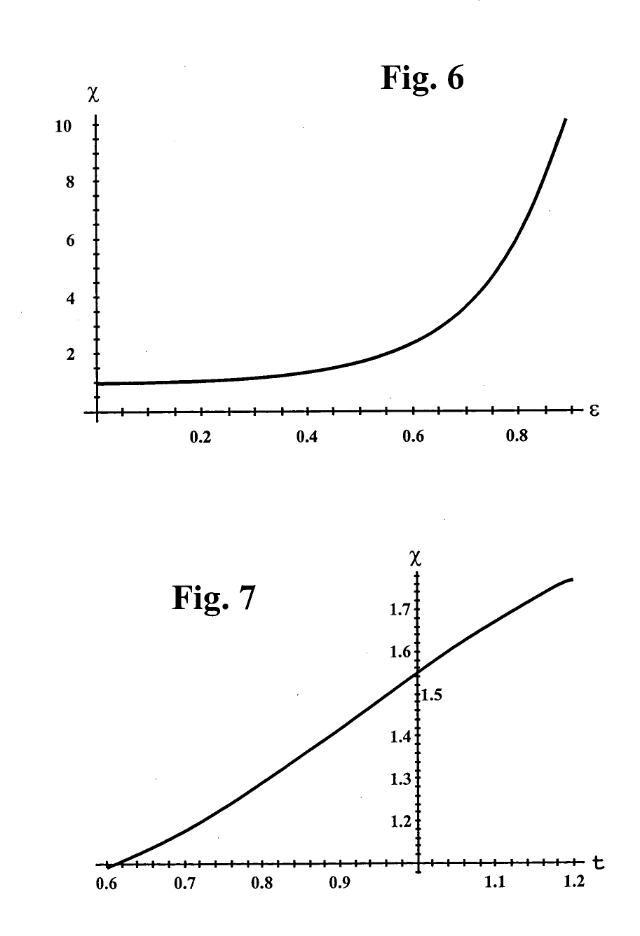

FIG. 6 is a schematic graphic representation showing the dependence of the gain factor λ on the width of the band gap v_{BG} at a temperature of 3,000K;

FIG. 7 is a schematic graphic representation showing the dependence of the gain factor χ on the temperature at a fixed value of the band gap (ε=vBG/v1=0.50).

In FIG. 1, the numeral 1 indicates as a whole an incandescent lamp according to the precepts of the present invention.

As in the prior art, the lamp 1 comprises a glass bulb, indicated with 2, in which a vacuum is created, and a screw base, indicated with 3.

Inside the bulb 2 two electric contacts are disposed, indicated schematically with 4 and 5, between which a three-dimensional tungsten structure or filament extends, produced according to the invention and indicated as a whole with 6; the contacts 4 and 5 are electrically connected to respective terminals formed in a known way in the screw base 3; connection of the screw base 3 in a respective lamp holder allows the lamp 1 to be connected to the electric power supply circuit, as schematized in FIG. 2.

According to the present invention, the filament 6 is structured to micrometric and nanometric dimensions, to form a sort of photonic crystal.

The underlying theory of photonic crystals originates from the works of Yablonovitch and translates into the possibility of producing materials with characteristics which influence the properties of the photons, just as semiconductor crystals influence the properties of electrons.

In 1987 Yablonovitch proved that materials with structures having a periodic variation in the refraction index may drastically modify the nature of the photonic modes inside them; this discovery offered new prospects in the field of control and manipulation of the transmission and emission properties of light from matter.

In greater detail, the electrons which move in a semiconductor crystal feel the effect of a periodic potential created by interaction with the nuclei of the atoms of which the crystal is composed; this interaction causes the formation of a series of allowed energy bands, separated by forbidden energy bands (Band Gap).

A similar phenomenon occurs for the photons in the photonic crystals, which are generally composed of blocks of transparent dielectric material containing an orderly series of microcavities in which air or another means with a very different refraction index to the index of the guest matrix is trapped. The contrast between the refraction indices causes confinement of photons with specific wavelengths inside the cavities of the photonic crystal.

The confinement which the photons (or the electromagnetic waves) feel the effect of due to the contrast between the refraction indices of the porous matrix and the cavities causes the formation of regions of permitted energies, separated by regions of prohibited energies. The latter are called Photonic Band Gaps (P.B.G.).

This fact gives rise to the two fundamental properties of photonic crystals:

i) by controlling the dimensions, the distance between the cavities and the difference between the refraction indexes, it is possible to prevent propagation and spontaneous emission of photons of specific wavelengths;

ii) as in the case of semiconductors, where there are dopant impurities inside the Photonic Band Gap (P.B.G.) it is possible to create permitted energy levels.

By appropriately selecting the values of the parameters which define the properties of the photonic crystals, it is therefore possible to prevent propagation and spontaneous emission of IR radiation of specific wavelengths, and simultaneously allow propagation and spontaneous emission of visible radiation.

FIG. 2 schematically shows a possible embodiment of the filament 6.

In this embodiment, the filament 6 is formed by a plurality of tungsten microfilaments, indicated with 6A, with a circular section, with a diameter ranging from 1.0 to 10.0 μm; the microfilaments 6A extend parallel to each other disposed at a distance in the order of 0.2 to 2.0 μm from each other, to form a band; the number of the microfilaments 6A is such that the sum of their sections is in the order of the section of a traditional filament for incandescent lamps. It must be noted that the number of microfilaments 6A may vary from a few tens to a few thousands in relation to the overall power of the light source.

In the case shown in FIG. 3, which uses the same reference numerals as the previous figure, the microfilaments 6A have rectangular sections and are disposed according to a reticulate or matrix structure, or formed of a number of series of microfilaments 6A which extend orthogonally over one another.

Irrespective of the embodiment chosen for the structure of the filament 6, the microfilaments 6A of which it is composed are disposed so as to produce a series of microcavities, in which there is a means with a very different refraction index to the index of the tungsten; as explained previously, by controlling the dimensions, the distance between the aforesaid microcavities and the difference between the refraction indexes, it is possible to prevent propagation and spontaneous emission of photons of specific wavelengths.

By selecting these parameters appropriately, it is therefore possible to prevent propagation and spontaneous emission of infrared radiation of specific wavelengths, and to simultaneously allow propagation and spontaneous emission of visible radiation. This makes it possible to obtain, for the tungsten filament 6 according to the invention, an efficiency reaching 20-30%, that is a decidedly higher efficiency than the efficiency of traditional incandescent lamps. The increase in efficiency made possible by the invention evidently translates into a considerable saving of energy.

An evaluation of the efficiency of an incandescent lamp equipped with a tungsten filament structured according to the invention is as follows.

The radiation spectrum issued by a black body is given by Planck's formula, which expresses the energy density of radiation as a function of frequency:

$$P ( ν ) = \frac{h ν}{{ⅇ}^{h ν / kT} - 1} g ( ν ) = h ν g ( ν ) f ( ν )$$

where v is the frequency, k the Boltzman constant, T the temperature, f(v) is the Bose-Einstein formula:

$$f ( ν ) = \frac{1}{{ⅇ}^{h ν / kT} - 1}$$

The function g(v) represents the density of the photonic states in the free space, which is:

$$g ( ν ) = \frac{8 π {ν}^{2}}{{c}^{3}}$$

where c is the speed of light.

FIG. 4 shows the typical spectrum of the black body radiation for sources of 3,000K, 6,000K and 12,000K respectively, where the dark zone represents the visible region (note that the curves are not to scale on the axis of the ordinates).

Between the visible light sources, the incandescent lamps with tungsten filament are limited in the temperature of the filament which may only reach 3,000K. From FIG. 4 it is evident how only a small fraction (about 5%) of the area which subtends the curve relative to the 3,000K source falls within the visible interval of the spectrum. Therefore, only 5% of the energy emitted by the 3,000K source is emitted in the form of visible light.

The efficiency of a light source is determined by:

$${η}_{0} = \frac{{\int }_{{v}_{1}}^{{v}_{2}} P ( ν ) ⅆ ν}{{\int }_{0}^{∞} P ( ν ) ⅆ ν}$$

where v₁=c/λ₁ and v₂=c/λ₂, as λ₁=700 nm and λ₂=400 nm are the ends of the visible interval of the electromagnetic spectrum.

The materials with photonic band gap (photonic crystals) have a modified black-body radiation emission in relation to that of traditional materials, due to the fact that the density of photonic states g_{BG}(v) in the materials with band gaps differs from that of traditional materials g(v). For this purpose, FIG. 5 is a schematic representation of the density of photonic states in a traditional material and in a material with band gap. In photonic crystals the position of the band gap is linked to the reticulate constant a. By acting on this parameter it is possible to place the band gap in the region of the most suitable spectrum for the needs.

Let us suppose that the band gap is in the vicinity of the visible interval of the spectrum, and that it is between v₀=c/λ₀ and v₁=c/λ₁, while the visible interval of the spectrum is between v₁=c/λ₁ and v₂=c/λ₂, with λ₁=700 nm and λ₂=400 nm.

Let us suppose that the band gap has a width of VBG and define the parameter ε:

$$ϵ = \frac{{ν}_{BG}}{{ν}_{1}}$$

which represents the value of the band gap normalized at its position (it would be more elegant to normalize v_{BG} on the frequency vₘ—center of the band gap, but for reasons of practicality we decide to normalize V_{BG} on the frequency v₁—upper end of the band gap).

Analogously to the case of traditional materials, it is possible to evaluate the efficiency of a light source made with a material with band gap:

$${η}_{BG} = \frac{{\int }_{{v}_{1}}^{{v}_{2}} h ν {g}_{BG} ( ν ) f ( ν ) ⅆ ν}{{\int }_{0}^{∞} h ν {g}_{BG} ( ν ) f ( ν ) ⅆ ν}$$

where g_{BG}(v) is the density of photonic states for a material with band gap, and f(v) is the Bose-Einstein formula indicated previously:

$$f ( ν ) = \frac{1}{{ⅇ}^{h ν / kT} - 1}$$

In the expression of the efficiency of a light source made with a material with band gap it is necessary to limit the integration of the denominator function to those intervals in which g_{BG}(v) differs from 0, therefore, simplifying the constants which appear both as numerator and as denominator:

$${η}_{BG} = \frac{{\int }_{{v}_{1}}^{{v}_{2}} {{ν}^{3} ( {ⅇ}^{h ν / kT} - 1 )}^{- 1} ⅆ ν}{{\int }_{0}^{∞} {{ν}^{3} ( {ⅇ}^{h ν / kT} - 1 )}^{- 1} ⅆ ν - {\int }_{{v}_{1} - {v}_{BG}}^{{v}_{1}} {{ν}^{3} ( {ⅇ}^{h ν / kT} - 1 )}^{- 1} ⅆ ν}$$

Let us then define the gain factor of the photonic crystals (or materials with band gap):

$$\begin{matrix}χ = \frac{{η}_{BG}}{{η}_{0}} \approx \frac{1}{1 - b} \\ with \\ b = \frac{{\int }_{{v}_{1} - {v}_{BG}}^{{v}_{1}} {{ν}^{3} ( {ⅇ}^{h ν / kT} - 1 )}^{- 1} ⅆ ν}{{\int }_{0}^{∞} {{ν}^{3} ( {ⅇ}^{h ν / kT} - 1 )}^{- 1} ⅆ ν}\end{matrix}$$

In actual fact the gain factor of the photonic crystals would be even greater than the one given by χ. In fact, the increase in the density of photonic states g_{BG}(v) in the visible interval found in photonic crystals compared with the density of photonic states g(v) of traditional materials has not been taken account of here. This increase is due to the fact that some forbidden photonic states are moved to higher frequencies and therefore in the visible interval of the electromagnetic spectrum.

FIGS. 6 and 7 show the dependency of the gain factor χ on some parameters.

In particular, FIG. 6 shows the dependency of the gain factor χ on the width of the band gap v_{BG} at a fixed temperature (T=3.000K). The axis of the abscissas indicates the value of the relative band gap ε=v_{BG}/v₁ and the axis of the ordinates the gain factor χ. FIG. 6 clearly shows that, at the temperature of 3,000K typical of the filament of an incandescent lamp, the gain factor χ increases exponentially and reaches values of over 2 (double the efficiency) for relative band gap values ε>0.5.

This means that an incandescent source, with a tungsten filament structured according to the invention with band gap in the nearby infrared, has an efficiency η_{BG} equal to at least twice (and more) the efficiency η₀ of an incandescent lamp with traditional filament.

FIG. 7 shows the dependency of the gain factor χ on the temperature at a fixed band gap value (ε=v_{BG}/v₁=0.50). The axis of the abscissas indicates the value of the temperature normalized at 2,500K (t=T/2,500) and the axis of the ordinates the gain factor χ.

Both the characteristics and the advantages of the invention are apparent from the description.

It is apparent to those skilled in the art that there are numerous possible variants to the tungsten structure and the light source utilizing the filament described as an example, without however departing from the intrinsic novelty of the invention.

What is claimed is:

1. Three-dimensional tungsten structure, in particular a filament, for an incandescent lamp, characterized in that it comprises a plurality of tungsten microfilaments (6A) with micrometric and/or nanometric dimensions, preferably with a circular or quadrangular section, disposed in the space to form a photonic crystal structure.

2. Structure according to claim 1, characterized in that said microfilaments (6A) are disposed so as to produce a series of microcavities within the structure, a means with a different refraction index to the tungsten being present within said microcavities.

3. Structure according to claim 1, characterized in that said microfilaments (6A) are distanced from one another so as to inhibit or limit the emission of a part of the infrared radiation.

4. Structure according to claim 3, characterized in that the distance between two adjacent microfilaments (6A) is in the order of 0.2 to 2.0 μm.

5. Structure according to claim 1, characterized in that said microfilaments (6A) have a diameter or section dimensions in the order of 1.0 to 10.0 μm.

6. Structure according to claim 1, characterized in that the sum of the sections of said microfilaments (6A) is in the order of the section of a traditional tungsten filament for incandescent lamps.

7. Structure according to claim 1, characterized in that the number of said microfilaments (6A) is variable from a few tens to a few thousands in relation to the overall power of the lamp.

8. Structure according to claim 1, characterized in that said microfilaments (6A) substantially extend in the same direction.

9. Structure according to claim 1, characterized in that said microfilaments (6A) are disposed according to a reticulate or matrix structure, in particular formed of a number of overlapping series of microfilaments (6A), the microfilaments of a series extending orthogonally in relation to those of the adjacent series.

10. Structure according to claim 1, characterized in that each end of said microfilaments (6A) is connected to a respective electric contact (4, 5).

11. Light source, in particular an incandescent lamp, comprising a bulb (2) inside which is disposed a three-dimensional tungsten structure (6A) produced according to claim 1.

12. Light source, in particular an incandescent lamp, comprising a bulb (2) inside which a three-dimensional tungsten structure (6A) is disposed, in particular a filament, characterized in that said structure (6A) is in the form of photonic crystal, that is defining a series of microcavities in which there is a means with a different refraction index to the tungsten.

13. Light source, according to claim 12, characterized in that said three-dimensional structure (6) includes a plurality of tungsten microfilaments (6A) with micrometric and/or nanometric dimensions.

14. Light source, according to claim 13, characterized in that said microfilaments (6A) have a diameter or section dimensions in the order of 1.0 to 10.0 μm, the number of said microfilaments (6A) being variable from a few tens to a few thousands in relation to the luminous power.

15. Light source, according to claims 13, characterized in that each end of said microfilaments (6A) is connected to a respective electric contact (4,5) present inside said bulb (2).
